(19) United States
(12) Patent Application Publication
(10) Pub. No.: US 2017/0298977 A1
(43) Pub. Date: Oct. 19, 2017

(54) SCREW BOLT, CASING FOR A TURBINE, TURBINE AND METHOD FOR ASSEMBLING A CASING OF A TURBINE

(71) Applicant: Siemens Aktiengesellschaft, Munich (DE)

(72) Inventors: Thomas Knobloch, Radeberg OT Liegau-Augustusbad (DE); Klaus Lochner, Markersdorf-Pfaffendorf (DE); Matthias Strauch, Leubsdorf (DE)

(73) Assignee: Siemens Aktiengesellschaft, Munich (DE)

(21) Appl. No.: 15/517,293

(22) PCT Filed: Sep. 15, 2015
(86) PCT No.: PCT/EP2015/071013

§ 371 Date: Apr. 6, 2017

(30) Foreign Application Priority Data
Oct. 29, 2014 (DE) 10 2014 222 060.2

(51) Int. Cl. F16B 33/00; H05B 6/10; F01D 25/24; B23P 11/02; F16B 5/02; F01D 25/26; H05B 6/38; F16B 35/00

(52) U.S. Cl. CPC F16B 33/002; H05B 6/38; H05B 6/101; F16B 35/005; B23P 11/025; F16B 5/0275; F01D 25/265; F01D 25/243; F05D 2260/31

(57) ABSTRACT

A screw bolt for connecting a lower casing part of a turbine and an upper casing part of a turbine, has a bolt body with a lower end and an upper end, an external thread being arranged on both the lower end and the upper end. A casing for a turbine has a lower casing part, an upper casing part, a screw bolt and two attachment nuts screwed onto ends of the screw bolt, wherein the upper casing part has an upper receiving section and the lower casing part has a lower receiving section of a continuous screw bolt receiving portion for receiving the screw bolt. A turbine has such a casing and a method for assembling such a casing of a turbine.

### CROSS REFERENCE TO RELATED APPLICATIONS

This application is the US National Stage of International Application No. PCT/EP2015/071013 filed Sep. 15, 2015, and claims the benefit thereof. The International Application claims the benefit of German Application No. DE 102014222060.2 filed Oct. 29, 2014. All of the applications are incorporated by reference herein in their entirety.

### FIELD OF INVENTION

The present invention relates to a screw bolt for connecting a lower casing part of a turbine and an upper casing part of a turbine, having a bolt body with a lower end and an upper end, wherein in each case one external thread is arranged on the lower end and on the upper end. The invention also relates to a casing for a turbine, having a lower casing part, an upper casing part, a screw bolt and two fixing nuts screwed onto ends of the screw bolt, wherein the upper casing part has an upper receptacle section and the lower casing part has a lower receptacle section of a continuous screw bolt receptacle for receiving the screw bolt. The invention furthermore relates to a turbine, having a casing, and furthermore to a method for assembling a casing of a turbine.

### BACKGROUND OF INVENTION

In modern technology, turbines are used in numerous sectors. Here, particularly widely used types of turbines include for example steam turbines. To ensure reliable operation of a turbine of said type, turbines according to the prior art have at least one casing in which, for example, there may be arranged a rotor shaft and a blade arrangement of the turbine. Often, turbines also have multiple casings, wherein in particular, a turbine of said type may also have an inner casing. In particular, inner casings of said type are normally formed in at least two parts in order to enable the casing to be arranged around, for example, a rotor shaft of the turbine.

According to the prior art, in particular in the case of inner casings, it is known for the two casing parts to be connected by way of screw connection. Here, the two casing parts together have a continuous receptacle for the screw, wherein a thread is often formed into the part of the screw receptacle in the lower casing part. A screw can thus be inserted through the part of the screw receptacle in the upper casing part and screwed to the lower casing part. Here, it has been found to be a disadvantage that adequate elasticity of the screw connection is often not ensured, whereby a loss of preload force of the screw may arise. Furthermore, in particular owing to a heat load during the operation of the turbine, the screwed-in screw can become seized with the thread in the lower casing part. Disassembly of the two casing parts, for example for maintenance purposes, is in this case no longer possible or is possible only with great effort. The same problem self-evidently also arises if the thread for the tightening of the screw is arranged in the upper casing part.

### SUMMARY OF INVENTION

It is an object of the present invention to at least partially solve the problems described above. In particular, it is an object of the invention to provide a screw bolt, a casing for a turbine, a turbine and a method for assembling a casing of a turbine, which permit assembly of a casing of a turbine in a simple and inexpensive manner.

The above object is achieved by way of a screw bolt and by way of a casing for a turbine having the features of the independent claims. The object is furthermore achieved by way of a turbine and by way of a method for assembling a casing of a turbine, having the features of the claims. Further objects, features and details of the present invention will emerge from the subclaims, from the description of preferred exemplary embodiments and from the drawings. Features and advantages which are described in conjunction with the screw bolt according to the invention are intended to likewise apply to the casing for a turbine, to a turbine and to the method for assembling a casing for a turbine and vise versa, such that reference is always or can always be made reciprocally with regard to the disclosure of the individual aspects of the invention.

According to a first aspect of the invention, the object is achieved by way of a screw bolt for connecting a lower casing part of a turbine and an upper casing part of a turbine, having a bolt body with a lower end and an upper end, wherein in each case one external thread is arranged on the lower end and on the upper end. A screw bolt according to the invention is characterized in that a support device for support on the lower casing part is arranged on the bolt body between the lower end and the upper end.

A screw bolt according to the invention may be used for connecting an upper casing part and a lower casing part to form a casing of a turbine. Here, a casing of said type may advantageously be an inner casing of the turbine. By contrast to the prior art, in which a thread is required in one of the casing parts, advantageously in the lower casing part, a screw bolt according to the invention has in each case one external thread on its upper end and on its lower end, onto which external thread a fixing nut can be screwed. The expressions “upper end” and “lower end” relate here in particular to the possible arrangement of the screw bolt relative to the two casing parts of the casing of the turbine. Here, if the screw bolt is arranged in a continuous screw bolt receptacle, the upper end of the screw bolt projects out of the upper casing part and the lower end of the screw bolt projects out of the lower casing part. Through the possibility of using external fixing nuts, adequate elasticity of the screw connection can be ensured, whereby the risk of a loss of preload force can be eliminated or at least considerably reduced. Also, the risk of seizing of a thread of the screw bolt in a thread in one of the casing parts is eliminated. The screw bolt furthermore has a bolt body which is advantageously at least substantially of cylindrical form. During an assembly process, for example of an inner casing of a turbine, it is often the case that the lower casing part is provided and those components of the turbine which are to be enclosed by the casing are arranged in said lower casing part. Subsequently, at least one screw bolt, self-evidently advantageously multiple screw bolts, are inserted into receptacles in the lower casing part. It is essential to the invention that a support device is arranged on the bolt body of a screw bolt according to the invention between the lower end and the upper end, advantageously centrally between the lower end and the upper end. Such a support device may in this case, as a separate component, be arranged on and/or fastened to the bolt body. A support device of said type is advantageously formed in one piece with the bolt body, in particular produced in monolithic form therewith. Here, a support device is arranged entirely on an outer side of the bolt body, whereby, in the region of the support device, an extent of the screw bolt perpendicular to its longitudinal extent is enlarged. In particular, in this way, it is possible for a screw bolt according to the invention to be supported by way of the support device on the lower casing part. Here, in the context of the invention, “support” refers in particular to the support device making contact with a surface of the lower casing part, wherein, in particular, it is possible for a position of a screw bolt along a direction of gravitational force to be axially defined. It is thereby possible to reliably prevent the screw bolt from falling or slipping through the receptacle in the lower casing part. The screw bolt can thus be inserted particularly easily into a receptacle in the lower casing part. The screw bolt is automatically axially held and supported on the lower casing part by the gravitational force and the form-fitting abutment of the support device against the lower casing part. Attachment of a fixing nut to the external thread at the lower end, which advantageously projects out of the lower casing part, is thereby particularly easily possible. To close the casing, the upper casing part is mounted onto the lower casing part, wherein the upper sections, which project out of the lower casing part, of the one or more screw bolts are insertable into suitable recesses of the upper casing part. It is in turn possible for fixing nuts to be screwed also the upper ends, which project out of the upper casing part after the mounting process, of the one or more screw bolts. Thus, assembly of a casing, in particular of an inner casing of a turbine, by way of a screw bolt is considerably simplified. Furthermore, the two casing parts are held together by fixing nuts which can be screwed onto the external thread on the upper end and lower end of the screw bolt. Inadequate elasticity of the screw connection, and seizing of the screw bolt with one of the two casing parts, such as are known as problems from the prior art, can thus be reliably avoided. Disassembly of a casing, for example for maintenance of the turbine, is also made possible, or at least considerably simplified, in this way.

Furthermore, in a screw bolt according to the invention, provision may be made for the support device to be arranged in circumferentially encircling fashion on the bolt body. Particularly good and in particular uniform support of the screw bolt on the lower casing part is made possible in this way. In particular, tilting of the screw bolt can thereby be prevented. This is advantageous in particular during the mounting of the upper casing part during the assembly of the casing.

Furthermore, a screw bolt according to the invention may be designed such that the support device is designed to engage into a support receptacle of the lower casing part. A particularly good axial partial form fit between the support device of the screw bolt and the lower casing part, in particular the support receptacle of the lower casing part, can be achieved in this way. The support device is advantageously designed such that, after engaging into the support receptacle of the lower casing part, it does not project, or at least does not significantly project, beyond an upper edge of the support receptacle. Particularly clear definition of a joint between the lower casing part and the upper casing part can thus be realized. Particularly good sealing of the casing at said joint is thus made possible. The subject matter of the present invention self-evidently also includes a lower casing part having a support receptacle of said type.

In a screw bolt according to the invention, provision may particularly advantageously also be made for the support device to have a rotation-preventing section, wherein the rotation-preventing section is designed to make contact, in form-fitting fashion, with at least one rotation-preventing region in one of the two casing parts, in particular in the support receptacle of the lower casing part. By way of such a rotation-preventing section which forms a form fit with a rotation-preventing region in one of the two casing parts, a rotation of the screw bolt can be reliably prevented. There is thus no need for a holding action, for example by way of a tool, when attaching a fixing nut to one of the external threads of the screw bolt. The rotation-preventing region is advantageously arranged in the support receptacle in the lower casing part. In this way, it is for example even possible for fixing nuts to be attached to the lower end of the screw bolt after insertion of the screw bolt into a receptacle of the lower casing part, without the screw bolt having to be additionally fixed. In particular in the case of use for an inner casing of a turbine, the assembly process is thereby greatly simplified. A time and thus cost saving in the assembly of a casing, in particular of an inner casing, can thereby be realized.

Furthermore, in a screw bolt according to the invention, provision may be made for the bolt body to have an opening which extends in continuous fashion between the lower end and the upper end. Such an opening thus extends, advantageously along a central axis of the screw bolt or so as to encompass the central axis of the screw bolt, from the upper end of the screw bolt to the lower end of the screw bolt. Such an opening is advantageously furthermore formed as a bore, wherein an opening of said type can be produced particularly easily by way of a bore. Here, it is for example possible for measurement devices for measuring a length of the screw bolt to be inserted into such an opening. Furthermore, it is made possible for heating devices, in particular inductive heating devices, to be inserted into the interior of the screw bolt, whereby heating of the screw bolt is particularly easily possible. By way of such heating and the associated length expansion of the screw bolt, it is possible for fixing nuts to be attached to the two ends of the screw bolt particularly easily, wherein, as a result of the subsequent length contraction during the cooling of the screw bolt, secure and firm fixing of the two casing parts to one another by way of the fixing nuts can be achieved particularly easily.

According to a second aspect of the invention, the object is achieved by way of a casing for a turbine, having a lower casing part, an upper casing part, a screw bolt and two fixing nuts screwed onto ends of the screw bolt, wherein the upper casing part has an upper receptacle section and the lower casing part has a lower receptacle section of a continuous screw bolt receptacle for receiving the screw bolt. A casing according to the invention is characterized in that the screw bolt has a support device, wherein the support device is supported on the lower casing part.

Here, a casing according to the invention may in particular be an inner casing of a turbine. For the casing, an upper casing part and a lower casing part are placed one on top of the other, wherein the casing parts are fixed to one another by a screw bolt. Here, it is self-evidently also possible for multiple such screw bolts to be provided in order to permit particularly good fixing of the two casing parts to one another. Here, the screw bolts are arranged in screw bolt receptacles which are made up of receptacle sections which are each arranged in the casing parts. To assemble such a casing, the individual components of the casing, that is to say at least the lower casing part, the upper casing part and the screw bolt, are joined together. Here, for a casing according to the invention, the lower casing part is normally provided, wherein, in particular, components of a turbine which are to be arranged within the casing may for example already be positioned on or in the lower casing part. One or more screw bolts are subsequently arranged in the lower receptacle sections of the continuous screw bolt receptacles in the lower casing part. It is essential to the invention that the screw bolts have a support device. Here, said support device is advantageously arranged on the screw bolts, after the screw bolts have been arranged in the lower receptacle section, said support device prevents the screw bolts from falling through the lower receptacle section and thus prevents the screw bolts from falling out of the lower casing part. Here, such support encompasses in particular form-fitting axial contact between the support device and the lower casing part. By way of this axial partial form fit, together with gravitational force, the screw bolt is held securely in a position in the lower receptacle section in the lower casing part. Following the arrangement of the one or more screw bolts, the upper casing part can be simply mounted onto the lower casing part and onto the one or more screw bolts projecting out of said lower casing part. Here, the screw bolts are inserted into upper receptacle sections in the upper casing part. Subsequently, fixing nuts can be screwed onto ends of the one or more screw bolts which project upward and downward out of the casing parts. Any other technically expedient sequence of the individual assembly steps is self-evidently also possible. For example, in particular if the casing is in the form of an inner casing, it may be provided that, after the screw bolts have been arranged in the lower casing part, these are immediately fixed by virtue of fixing nuts being screwed onto the ends which project downward out of the lower casing part.

It is thus possible, for example, for the lower casing part to be immediately arranged in a lower part of an outer casing of the turbine. In summary, the assembly of such a casing according to the invention is thus possible in a particularly straightforward manner. By avoiding a situation in which a screw is screwed directly into a thread in one of the casing parts, it is furthermore possible to reliably avoid sufficient elasticity of the screw connection and seizing of the screw bolt with one of the casing parts during the operation of the turbine. For disassembly, it is merely necessary for one of the two fixing nuts to be released, and for the adjacent casing part to be lifted off. Disassembly of a casing according to the invention is thus also possible particularly easily. This is a major advantage in particular in the case of inner casings of turbines.

In the casing according to the invention, it may particularly advantageously be provided that the screw bolt is designed according to the first aspect of the invention. All advantages that have been described with reference to a screw bolt according to the first aspect of the invention are thus self-evidently also obtained with a casing according to the invention which is equipped with such a screw bolt according to the first aspect of the invention.

Furthermore, in a casing according to the invention, provision may be made for the lower casing part to have a support receptacle, wherein the support receptacle at least partially receives the support device of the screw bolt. In particular, by way of a support receptacle of said type, an axial partial form fit between the support device of the screw bolt and the lower casing part can be achieved particularly easily. Here, the support receptacle is advantageously designed such that the support device can be received entirely by the support receptacle. The support device thus does not project beyond the upper edge of the support receptacle. Flange surfaces of the casing parts can thus be arranged directly one on top of the other, whereby a flange joint between the two casing parts can be of particularly defined form. Particularly good sealing of the two casing parts can thus be achieved.

A casing according to the invention may also be designed such that the support device has a rotation-preventing section and at least one of the two casing parts has a rotation-preventing region, wherein the rotation-preventing section is designed to make contact, in form-fitting fashion, with the rotation-preventing region. To connect the two casing parts to form a casing, fixing nuts are screwed onto ends of the screw bolt. By way of such a rotation-preventing section which forms a form fit with a rotation-preventing region in one of the two casing parts, such screwing of fixing nuts onto ends of the screw bolt is possible particularly easily. A reason for this is in particular that, owing to the form fit of the rotation-preventing section and of the rotation-preventing region, the screw bolt is fixed such that rotation of the screw bolt, that is to say in particular turning of the screw bolt about its central axis, is prevented. There is thus no need for an additional holding action, for example by way of a tool, when attaching the fixing nuts. The attachment of the fixing nuts can thereby be made easier.

In a further development of a casing according to the invention, provision may furthermore be made for the rotation-preventing region to be formed as part of the support receptacle. In this way, it can be made possible in particular that, already after insertion of the screw bolt into the lower receptacle section in the lower casing part, a fixing nut can be attached to the lower end of the screw bolt without the need for the screw bolt to be additionally fixed. Furthermore, in this way, the one or more screw bolts can be firstly securely held and secondly fixed so as to be prevented from rotating by the lower casing part alone, whereby mounting of the upper casing part on the lower casing part is made easier. Altogether, by way of such an embodiment of a casing according to the invention, the assembly of a casing according to the invention can be simplified yet further.

Furthermore, in a casing according to the invention, provision may be made for at least one of the fixing nuts to be in the form of a capped nut. Such capped nuts are in particular smaller than conventional hexagonal nuts. In particular if a casing according to the invention is used as an inner casing of a turbine, this is a major advantage, because the structural space in the interior of a turbine is limited. A smaller embodiment of fixing nuts owing to the use of capped nuts thus constitutes an advantage in particular in the case of inner casings.

According to a third aspect of the invention, the object is achieved by way of a turbine, having a casing. A turbine according to the invention is characterized in that the casing is designed according to the second aspect of the invention. All advantages that have been described with reference to a casing according to the second aspect of the invention are thus self-evidently also obtained with a turbine which has such a casing according to the second aspect of the invention.

According to a fourth aspect of the invention, the object is achieved by way of a method for assembling a casing of a turbine according to the second aspect of the invention. A method according to the invention is characterized here by the following steps: a) inserting a screw bolt into an end position in a lower receptacle section of a screw bolt receptacle in the lower casing part, wherein, in the end position, a support device of the screw bolt is supported on the lower casing part, b) attaching a fixing nut to a lower end of the screw bolt, c) mounting an upper casing part onto the lower casing part, wherein, in the process, the screw bolt is inserted into an upper receptacle section of the screw bolt receptacle in the upper casing part, and d) attaching a fixing nut to an upper end of the screw bolt.

A casing of a turbine according to the second aspect of the invention is assembled by way of a method according to the invention. All advantages that have been described with reference to a casing according to the second aspect of the invention are thus self-evidently also obtained with a method for assembling such a casing according to the second aspect of the invention. Below, the method will be described on the basis of one screw bolt, and it is self-evidently also possible for the method to be correspondingly carried out with multiple screw bolts.

In a first step a) of a method according to the invention, a screw bolt is inserted into an end position in a lower receptacle section of a screw bolt receptacle in the lower casing part. A screw bolt of a casing according to the second aspect of the invention has, in particular, a support device. As soon as the screw bolt is situated in its end position, said support device forms an axial partial form fit with the lower casing part. Said partial form fit, in interaction with gravitational force, causes the screw bolt to be securely held in the lower receptacle section of the screw bolt receptacle. In particular, the partial form fit of the support device and of the lower casing part reliably prevents the screw bolt from falling through the lower receptacle section.

In step b) of the method according to the invention, a fixing nut is attached to a lower end of the screw bolt. Here, it is self-evidently possible for an external thread to be arranged on the lower end of the screw bolt, wherein furthermore, the lower end projects out of the lower casing part to such an extent that the fixing nut can be attached to it. Here, an attachment of the fixing nut encompasses in particular a tightening of the fixing nut, and tightening with a limited torque is also conceivable. In one of the embodiments of a casing according to the invention, provision is made in particular for the screw bolt to have a rotation-preventing section and for the lower casing part to have a rotation-preventing region, wherein the rotation-preventing section and the rotation-preventing region form a form fit. Said form fit reliably prevents a rotation and thus turning of the screw bolt about its longitudinal axis, whereby the attachment of the fixing nut to the lower end of the screw bolt is further simplified. It is thus possible to eliminate the need for a holding action during the attachment of the fixing nut, for example by way of an additional tool.

Subsequently, in step c) of a method according to the invention, an upper casing part is mounted onto the lower casing part, wherein in particular, the screw bolt projecting out of the lower casing part are inserted into an upper receptacle section of the continuous screw bolt receptacle in the upper casing part. It is self-evidently possible here, before the mounting of the upper casing part, for components of the turbine that are subsequently to be situated within the casing to be arranged on or in the lower casing part.

Finally, in a step d) of a method according to the invention, a fixing nut is attached to an upper end of the screw bolt. Here, too, an attachment of a fixing nut encompasses in particular a tightening of the fixing nut, and also tightening with a limited torque. The screw bolt is self-evidently designed here such that, firstly, it has an external thread on its upper end and such that, secondly, the upper end of the screw bolt projects out of the upper casing part to such an extent that the fixing nut can be attached to the external thread. Here, too, in the particularly advantageous embodiment of a casing according to the invention with a rotation-preventing section on the screw bolt and with a rotation-preventing region in particular in the lower casing part, an attachment of the fixing nut can be simplified.

In the method according to the invention, aside from a sequential progression of the steps in the sequence a), b), c) and d), an embodiment is self-evidently also conceivable in which the steps are performed in the sequence a), c), b) and d), wherein, in the second variant, the steps b) and d) may also be interchanged or even performed simultaneously.

Altogether, a casing according to the second aspect of the invention can be assembled by way of a method according to the invention. Through the use, in particular, of a screw bolt with a support device, the assembly of a casing of a turbine, in particular of an inner casing of a turbine, can be considerably simplified.

In a further development of a method according to the invention, provision may furthermore be made for the screw bolt to be heated, in particular inductively heated, before step c) and/or step d). Such heating causes the screw bolt to expand, in particular parallel to its longitudinal extent. The two ends of the screw bolt which bear external threads and which project beyond the two casing parts thus project slightly further still out of the casing parts after the heating. Fixing nuts, for example capped nuts, can then be screwed onto the external threads particularly easily, in particular so as to form a form fit with the casing parts. Cooling of the screw bolt after the heating causes the screw bolt to contract again. The form fit between the fixing nuts and the casing parts is thereby further intensified, and the fixing nuts are pressed against the casing parts. Particularly good fixing of the two casing parts to one another can thereby be achieved. In particular, it may also be provided that the heating is performed by way of an inductive method. It has been found here that particularly rapid heating of the screw bolt can be achieved by way of such inductive methods. This, too, constitutes a time and thus cost saving during the assembly of a casing according to the invention.

In a further development of a method according to the invention, provision may furthermore be made for a length of the screw bolt to be measured before the heating and after step d). Here, a length of the screw bolt is in particular the extent of the screw bolt between its lower end and its upper end. Here, prior to the assembly of the casing, it is in particular possible, for example by way of calculations, for an advantageous length of the screw bolt to be determined. By measuring the length before the heating and after step d), it can be ensured that, in the assembled state, the screw bolt has a length which corresponds exactly, or at least substantially, to the predetermined ideal length. For example, it is advantageously possible by way of an iterative process, that is to say by repeatedly performing the heating and steps c) and/or d), to ensure that said predetermined ideal length of the screw bolt is attained. A particularly advantageous embodiment of a casing according to the invention can thereby be obtained.

All refinements, variants and modifications of the invention, considered individually, are independent embodiments of the invention.

### BRIEF DESCRIPTION OF THE DRAWINGS

The present invention will be described below on the basis of the appended drawings, in which, schematically in each case:

FIG. 1 shows a screw bolt according to the invention,

FIG. 2 shows a lower casing part with an inserted screw bolt according to the invention, and

FIG. 3 shows a sectional drawing of a casing according to the invention of a turbine.

### DETAILED DESCRIPTION OF INVENTION

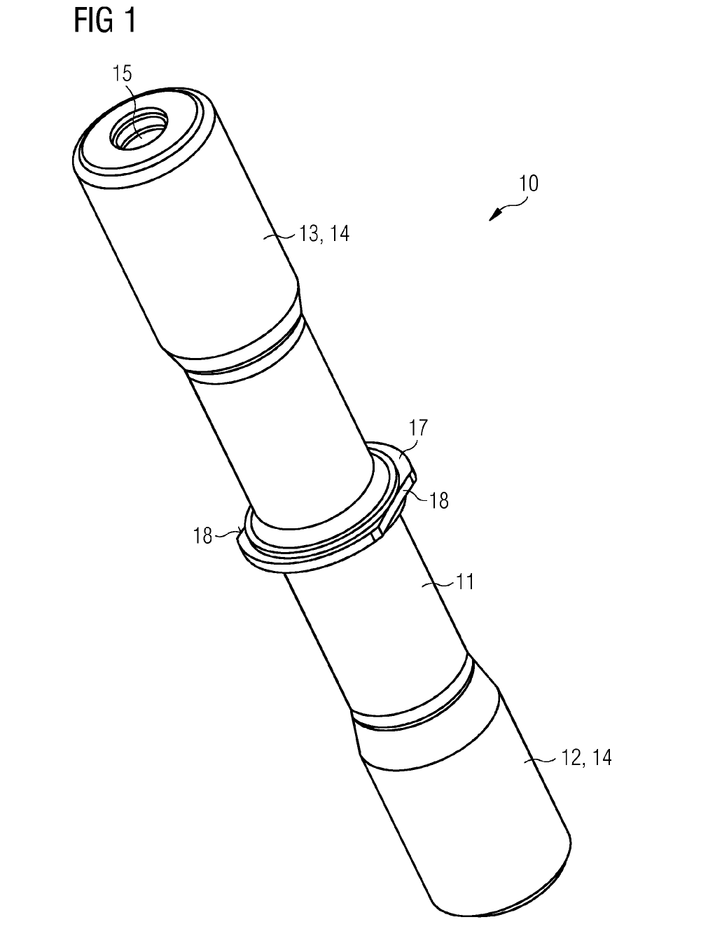

Elements of identical function and mode of operation are denoted in each case by the same reference designations in FIGS. 1, 2 and 3.

FIG. 1 shows a screw bolt 10 according to the invention. A screw bolt 10 according to the invention has, in particular, a bolt body 11. The bolt body 11 has in each case one external thread 14 on a lower end 12 and on an upper end 13. In particular, a fixing nut 22 (not shown) can be screwed onto said external threads 14. In particular, a screw bolt 10 according to the invention has a support device 17. In the illustrated embodiment of a screw bolt 10 according to the invention, said support device 17 is arranged in the middle between the two ends 12, 13 of the screw bolt 10. The bolt body 11 of the screw bolt 10 is of substantially cylindrical form, wherein a radial extent of the screw bolt 10 is increased by way of the support device 17. In particular, it is thereby possible for a screw bolt 10 to be supported on a lower casing part 20 (not shown) by way of a form fit of the support device 17 with the lower casing part 30 when the screw bolt 10 is inserted into a receptacle of the lower casing part 30. The screw bolt 10 is thus reliably prevented from falling through the receptacle in the lower casing part 30. In particular, the illustrated support device 17 is of circumferentially encircling form, whereby tilting of the screw bolt 10 in the receptacle of the lower casing part 30 can also be prevented. Furthermore, in the embodiment shown, the screw bolt 10 according to the invention has rotation-preventing sections 18 on its support device 17. Said rotation-preventing sections 18 are in this case in particular designed such that, as shown, the support device 17 is not radially symmetrical. In particular by way of a form fit with a rotation-preventing region 33 in a casing part 30, 40 (not shown), it is thus possible for the screw bolt 10 to be reliably prevented from rotating, in particular during the attachment of fixing nuts 22 (not shown) to the external threads 14. There is thus no need for additional fixing or holding of the screw bolt 10, for example by way of an additional tool. Furthermore, the screw bolt 10 has an opening 15 which extends in continuous fashion in particular between the two ends 12, 13 of the screw bolt 10. For example, measurement tools for measuring a length of the screw bolt, or a heating device, may be inserted into such an opening 15. By measuring the length of the screw bolt, it can be ensured that the screw bolt has, even after the assembly of the casing 20 (not shown), a length which is ideal for the casing 20. By heating the screw bolt 10, it is furthermore possible to realize greater strength in the attachment of fixing nuts 22. Heating causes the screw bolt 10 to expand. Then, during the assembly of the casing, fixing nuts 22 are screwed onto the external thread 14, in particular so as to bear in form-fitting fashion against the casing 20. After the screw bolt 10 cools, it contracts again, whereby particularly good fixing of the fixing nuts 22 on the casing 20 can be realized. Assembly of a casing 20, in particular of an inner casing, of a turbine 50 (not shown) can thereby be simplified.

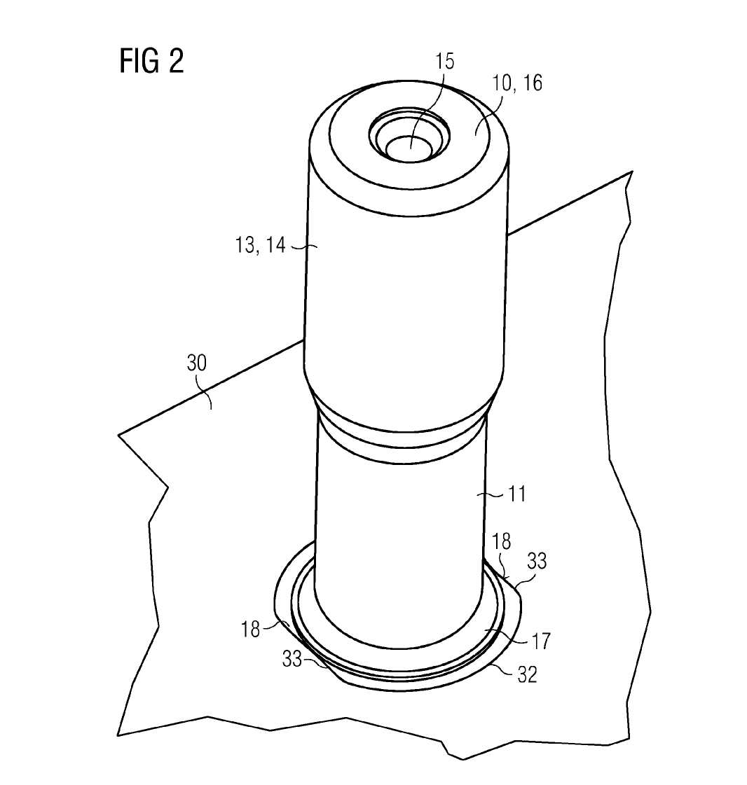

FIG. 2 shows a screw bolt 10 according to the invention which is arranged in a receptacle in a lower casing part 30. This corresponds to the state, during the assembly of a casing 20 (not shown), after the step a) of a method according to the invention. Here, the screw bolt 10 is situated in its end position 16. The upper end 13 with the external thread 14 projects out of the lower casing part 30, with the opening 15 in the screw bolt 10 also being accessible. The illustrated lower casing part 30 has, in particular, a support receptacle 32. The support device 17 is in particular positioned in said support receptacle 32, wherein the support device 17 also does not project beyond the support receptacle 32. Attachment of an upper casing part 40 (not shown) to the surface of the lower casing part 30 is thus possible without parts of the screw bolt 10 becoming clamped between the casing parts 30, 40. Furthermore, the support device 17 forms an axial partial form fit with the support receptacle 32, whereby the screw bolt 10 is prevented from advancing further from its end position 16 into the lower casing part 30. Furthermore, the support device 17 has a rotation-preventing section 18 which likewise forms a form fit with a rotation-preventing region 33 of the support receptacle 32. Rotation of the screw bolt 10 is thus reliably prevented. When fixing nuts 22 (not shown) are attached for example to the upper end 13 of the screw bolt 10, there is thus no need for an additional tool to prevent the screw bolt 10 from also turning. This, too, simplifies the assembly of a casing 20 (not shown).

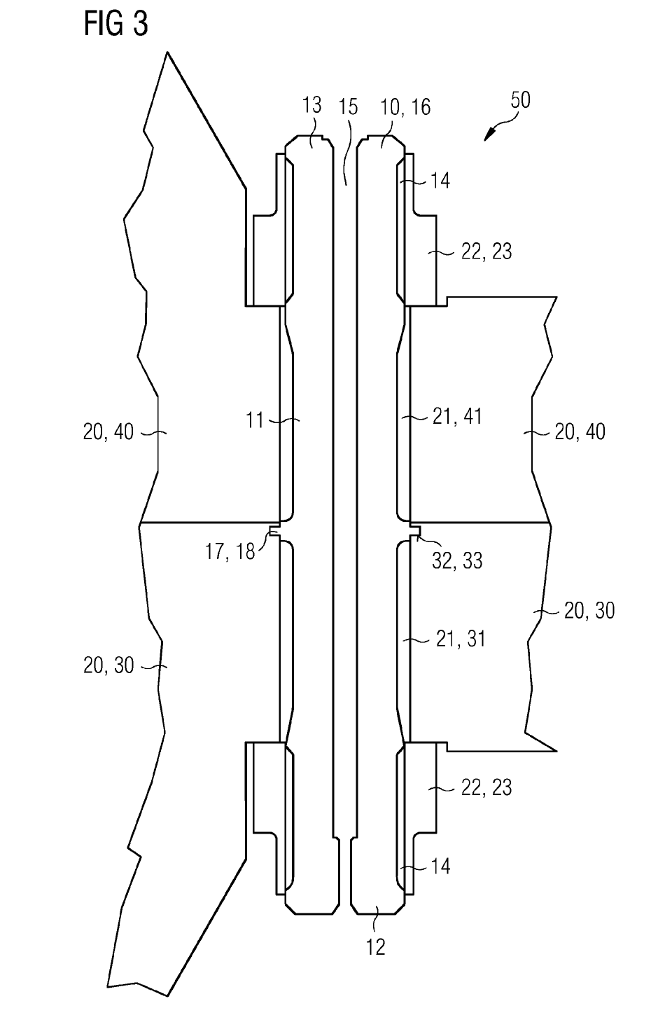

FIG. 3 shows a sectional illustration of a casing 20 of a turbine 50. The casing 20 in this case has a lower casing part 30 and an upper casing part 40. The two casing parts 30, 40 form a continuously extending screw bolt receptacle 21 which is divided into a lower receptacle section 31 in the lower casing part 30 and an upper receptacle section 41 in the upper casing part 40. A screw bolt 10 according to the invention is inserted into said continuously extending screw bolt receptacle 21. It is possible to clearly see that the lower end 12 and the upper end 13, each equipped with external threads 14, project out of the respective casing part 30, 40. Here, fixing nuts 22 in the form of capped nuts 23 are arranged on the external threads 14. It is also possible to clearly see the small radial space requirement of such capped nuts 23. The screw bolt 10 is in its end position 16. Here, in a manner which is essential to the invention, the screw bolt 10 has a support device 17. Said support device 17, by way of an axial partial form fit with the lower casing part 30, prevents the screw bolt 10 from falling through when the screw bolt 10 is inserted into the continuously extending screw bolt receptacle 21. In particular, in the embodiment shown, there is provided in the lower casing part 30 a support receptacle 32 into which the support device 17 engages. In the embodiment illustrated, the support receptacle 32 is furthermore designed to completely receive the support device 17. The two casing parts 30, 40 can thus bear flat against one another, whereby particularly good sealing of the casing 20 can be achieved. Furthermore, in the embodiment shown, there is provided on the support device 17 a rotation-preventing section 18 which is designed to form a form fit with a rotation-preventing region 33 of the support receptacle 32. Said form fit can reliably prevent rotation of the screw bolt 10, whereby, in particular, attachment of the fixing nuts 22 to the external thread 14 on the lower end 12 and on the upper end 13 of the screw bolt 10 is possible more easily. Additional fixing of the screw bolt 10 to prevent it from rotating, for example by way of an external tool, can thereby be avoided. Furthermore, the screw bolt 10 has a central opening 15 which extends in continuous fashion through the screw bolt 10 from the lower end 12 to the upper end 13. Here, it is for example possible, firstly, for a measurement instrument, for example for measuring the length of the screw bolt, to be inserted into such an opening 15. In this way, it can be established whether the screw bolt has a length ideal for the operation of the turbine 50 and/or for example for the sealing action of the casing 20. Furthermore, a heating device, in particular an induction heating device, for heating the screw bolt 10 may be inserted into the opening 15. This has advantages for example in the attachment and retroactive fixing of the fixing nuts 22. When heated, the screw bolt 10 expands in particular along its longitudinal extent. Fixing nuts 22 are then screwed onto the still-hot screw bolt 10, in particular until they come to bear against the respective casing part 30, 40. As it cools, the screw bolt 10 contracts again, whereby the fixing nuts 22 are pressed against the respective casing part 30, 40. Particularly good fixing of the two casing parts 30, 40 to form a casing 20 of a turbine 50 can thereby be achieved.

1. A screw bolt for connecting a lower casing part of a turbine and an upper casing part of a turbine, comprising:
a bolt body with a lower end and an upper end, wherein in each case one external thread is arranged on the lower end and on the upper end, and
a support device for support on the lower casing part is arranged on the bolt body between the lower end and the upper end.

2. The screw bolt as claimed in claim 1,
wherein the support device is arranged in circumferentially encircling fashion on the bolt body.

3. The screw bolt as claimed in claim 1,
wherein the support device is designed to engage into a support receptacle of the lower casing part.

4. The screw bolt as claimed in claim 1,
wherein the support device has a rotation-preventing section, wherein the rotation-preventing section is designed to make contact, in form-fitting fashion, with at least one rotation-preventing region in one of the two casing parts.

5. The screw bolt as claimed in claim 1,
wherein the bolt body has an opening which extends in continuous fashion between the lower end and the upper end.

6. A casing for a turbine, comprising:
a lower casing part,
an upper casing part,
a screw bolt and two fixing nuts screwed onto ends of the screw bolt,
wherein the upper casing part has an upper receptacle section and the lower casing part has a lower receptacle section of a continuous screw bolt receptacle for receiving the screw bolt,
wherein the screw bolt has a support device, wherein the support device is supported on the lower casing part.

7. The casing as claimed in claim 6,
wherein the screw bolt comprises a bolt body with a lower end and an upper end, wherein in each case one external thread is arranged on the lower end and on the upper end, and wherein the support device for support on the lower casing part is arranged on the bolt body between the lower end and the upper end.

8. The casing as claimed in claim 6,
wherein the lower casing part has a support receptacle, wherein the support receptacle at least partially receives the support device of the screw bolt.

9. The casing as claimed in claim 6,
wherein the support device has a rotation-preventing section and at least one of the two casing parts has a rotation-preventing region, wherein the rotation-preventing section is designed to make contact, in form-fitting fashion, with the rotation-preventing region.

10. The casing as claimed in claim 9,
wherein the rotation-preventing region is formed as part of the support receptacle.

11. The casing as claimed in claim 6,
wherein at least one of the fixing nuts is in the form of a capped nut.

12. A turbine, comprising:
a casing,
wherein the casing is designed as claimed in claim 6.

13. A method for assembling a casing of a turbine, wherein the casing is as claimed in claim 6 the method comprising:
a) inserting a screw bolt into an end position in a lower receptacle section of a screw bolt receptacle in the lower casing part, wherein, in the end position, a support device of the screw bolt is supported on the lower casing part,
b) attaching a fixing nut to a lower end of the screw bolt,
c) mounting an upper casing part onto the lower casing part, wherein, in the process, the screw bolt is inserted into an upper receptacle section of the screw bolt receptacle in the upper casing part, and
d) attaching a fixing nut to an upper end of the screw bolt.

14. The method as claimed in claim 13,
wherein the screw bolt is heated before step d).

15. The method as claimed in claim 14,
wherein a length of the screw bolt is measured before the heating and after step d).

16. The screw bolt as claimed in claim 4,
wherein the at least one rotation-preventing region in one of the two casing parts, is the support receptacle of the lower casing part.

17. The method of claim 14,
wherein the screw bolt is inductively heated before step d).
